(19) United States
(12) Patent Application Publication
(10) Pub. No.: US 2025/0095936 A1
(43) Pub. Date: Mar. 20, 2025

(54) RELAY

(71) Applicant: Xiamen Hongfa Electric Power Controls Co., Ltd., Xiamen (CN)

(72) Inventors: Wenguang Dai, Xiamen (CN); Meng Wang, Xiamen (CN); Jinpin Chen, Xiamen (CN); Liji Su, Xiamen (CN); Yiwen Wu, Xiamen (CN)

(21) Appl. No.: 18/883,819

(22) Filed: Sep. 12, 2024

(30) Foreign Application Priority Data
Sep. 14, 2023 (CN) 2023111877872

(51) Int. Cl. H01H 45/02; H01H 45/14

(52) U.S. Cl. CPC H01H 45/02; H01H 45/14

(57) ABSTRACT

A relay includes a pair of static contact leading-out terminals; a movable contact assembly including a movable contact piece are configured to contact with or separate from the pair of static contact leading-out terminals along a first direction; the movable contact assembly has a first and a second side surfaces along a third direction; wherein a moving direction of the movable contact piece, the first direction, and the third direction are perpendicular with each other; a push rod assembly including a contact bracket; the contact bracket has a first side wall corresponding to the first side surface and a second side wall corresponding to the second side surface along the third direction; and an anti-rotation structure including a first anti-rotation piece located between the first side wall and the first side surface and a second anti-rotation piece located between the second side wall and the second side surface.

### CROSS REFERENCE

This application is based upon and claims priority to Chinese Patent Application No. 2023111877872, filed on Sep. 14, 2023, the entire contents thereof are incorporated herein by reference.

### TECHNICAL FIELD

The present disclosure relates to the technical field of electronic control devices, specifically to a relay.

### BACKGROUND

A relay is an electronic control device that has a control system (also known as an input circuit) and a controlled system (also known as an output circuit), and is typically used in automatic control circuits. Essentially, the relay is an “automatic switch” that uses a smaller current to control a larger current. Therefore, it plays roles such as automatic regulation, safety protection, and circuit switching in electrical circuits.

A high-voltage DC relay is a type of relay. In the prior art, the high-voltage DC relay includes a pair of static contact leading-out terminals, a movable assembly, a coil unit and a magnetic circuit part. The movable assembly includes a movable contact assembly, a push rod assembly and an elastic assembly. The movable contact assembly is installed on the push rod assembly through the elastic assembly. The magnetic circuit part includes a static iron core and a movable iron core. The static iron core is fixed in the relay, and the movable iron core is connected to the push rod assembly. When the coil unit is energized, the static iron core can generate magnetic attraction force and attract the movable iron core to move, thereby driving the push rod assembly together with the movable contact assembly to move to achieve the closure of the contacts.

However, during the operation of the relay, the movable contact assembly is prone to rotate around the axis of the push rod relative to the push rod, resulting in friction between the movable contact assembly and the contact bracket of the push rod assembly, thereby generating a large metal noise; furthermore, with the friction loss between the movable contact assembly and the contact bracket, the deflection angle of the movable contact assembly will become larger and larger, thereby affecting the contact position between the movable contact assembly and the static contact leading-out terminal, resulting in unstable contact resistance. In addition, metal particles are easily generated after friction between the movable contact assembly and the contact bracket. When the metal particles fall on the contact surface of the contact, it is easy to cause the contact resistance to increase or even cause the relay to fail to conduct.

### SUMMARY

The relay of the embodiment of the present disclosure includes:
a pair of static contact leading-out terminals;
a movable contact assembly, including a movable contact piece, two ends of the movable contact piece along a first direction are configured to contact with or separate from the pair of static contact leading-out terminals respectively; the first direction is an arrangement direction of the pair of static contact leading-out terminals, the movable contact assembly has a first side surface and a second side surface arranged along a third direction; wherein a moving direction of the movable contact piece is defined as a second direction, and the first direction, the second direction and the third direction are perpendicular with each other;
a push rod assembly, including a contact bracket; the contact bracket has a first side wall and a second side wall along the third direction, the first side wall corresponds to the first side surface, the second side wall corresponds to the second side surface; and
an anti-rotation structure, including a first anti-rotation piece and a second anti-rotation piece, the first anti-rotation piece is located between the first side wall and the first side surface, the second anti-rotation piece is located between the second side wall and the second side surface.

According to some embodiments of the present disclosure, wherein the first anti-rotation piece and the second anti-rotation piece are both sheet structures made of flexible materials;
the first side wall has a first inner side surface facing the movable contact assembly, the first anti-rotation piece is attached to the first inner side surface or the first side surface; the second side wall has a second inner side surface facing the movable contact assembly, and the second anti-rotation piece is attached to the second inner side surface or the second side surface.

According to some embodiments of the present disclosure, wherein the first anti-rotation piece and the second anti-rotation piece are both elastic pieces;
the first anti-rotation piece is compressed between the first side wall and the first side surface of the movable contact assembly, configured to provide a first elastic force to the movable contact assembly; the second anti-rotation piece is compressed between the second side wall and the second side surface of the movable contact assembly, configured to provide a second elastic force to the movable contact assembly;
a direction of the first elastic force is opposite to a direction of the second elastic force.

According to some embodiments of the present disclosure, wherein the first anti-rotation piece and the second anti-rotation piece each includes a connection portion and an elastic sheet portion;
two connection portions of the first anti-rotation piece and the second anti-rotation piece are respectively connected to the first side wall and the second side wall, two elastic sheet portions of the first anti-rotation piece and the second anti-rotation piece extend from the two connection portions respectively in a direction away from the static contact leading-out terminal; the two elastic sheet portions are configured to provide the first elastic force and the second elastic force to the movable contact assembly respectively.

According to some embodiments of the present disclosure, wherein the connection portion of the first anti-rotation piece is riveted to the first inner side surface of the first side wall facing the movable contact assembly, the connection portion of the second anti-rotation piece is riveted to the second inner side surface of the second side wall facing the movable contact assembly.

According to some embodiments of the present disclosure, wherein the first side wall is provided with a first opening and the second side wall is provided with a second opening;
each connection portion includes a hanging hook, two hanging hooks of the two connection portions are respectively hung on a lower edge of the first opening and a lower edge of the second opening.

According to some embodiments of the present disclosure, wherein the first side wall is provided with a first opening and the second side wall is provided with a second opening;
each connection portion includes a clamping structure, and the clamping structures of the two connection portions are respectively clamped in the first opening and the second opening.

According to some embodiments of the present disclosure, wherein the first side wall is further provided with a first connecting hole, the second side wall is further provided with a second connecting hole;
each connection portion further includes a protrusion, and the protrusions of the two connection portions extend in the first connecting hole and the second connecting hole, and are interference-fitted with the first connecting hole and the second connecting hole, respectively.

According to some embodiments of the present disclosure, wherein the first side wall and the second side wall are both provided with a protruding claw;
each connection portion includes a sleeve ring, the sleeve rings of the two connection portions are respectively sleeved on a periphery of the protruding claw of the first side wall and a periphery of the protruding claw of the second side wall.

According to some embodiments of the present disclosure, wherein the anti-rotation structure further includes a connection piece;
one end of the first anti-rotation piece and one end of the second anti-rotation piece are respectively integrally connected to two ends of the connection piece along the third direction.

According to some embodiments of the present disclosure, wherein the connection piece has a center hole;
the relay further includes an elastic assembly, the elastic assembly is connected to the movable contact assembly and the push rod assembly; the elastic assembly is configured to provide a contact pressure to a movable contact assembly;
the elastic assembly passes through the center hole.

According to some embodiments of the present disclosure, wherein the anti-rotation structure further includes a connection piece;
one end of the first anti-rotation piece and one end of the second anti-rotation piece are respectively integrally connected to two ends of the connection piece along the third direction;
the connection piece is fixedly connected to the movable contact assembly.

According to some embodiments of the present disclosure, wherein the movable contact assembly further includes a second magnetizer, the second magnetizer is fixedly connected to one side of the movable contact piece facing away from the static contact leading-out terminal;
the connection piece is fixedly connected to the second magnetizer.

According to some embodiments of the present disclosure, wherein the anti-rotation structure further includes a connection piece;
one end of the first anti-rotation piece and one end of the second anti-rotation piece are respectively integrally connected to two ends of the connection piece along the third direction;
the push rod assembly further includes a stop wall, two ends of the stop wall along the third direction are connected to the first side wall and the second side wall;
the connection piece is fixedly connected to the stop wall.

According to some embodiments of the present disclosure, wherein the relay further includes a first magnetizer, the first magnetizer is disposed at one side of the movable contact assembly facing the static contact leading-out terminal;
the connection piece is disposed between the stop wall and the first magnetizer, and is fixedly connected to the stop wall and the first magnetizer.

According to some embodiments of the present disclosure, wherein the first anti-rotation piece is integrally connected to the first side wall, the second anti-rotation piece is integrally connected to the second side wall.

According to some embodiments of the present disclosure, wherein the push rod assembly further includes a rod portion and a base connected to one end of the rod portion along an axial direction;
the contact bracket further includes a bottom wall, and the two ends of the bottom wall along the third direction are integrally connected to one ends of the first side wall and the second side wall, the contact bracket, the rod portion and the base are connected by injection molding, and the base wraps the bottom wall and one ends of the first side wall and the second side wall.
the push rod assembly further includes a stop wall, the stop wall is connected to another ends of the first side wall and the second side wall, and the stop wall is arranged at one side of the movable contact assembly facing the static contact leading-out terminal.

According to some embodiments of the present disclosure, wherein the push rod assembly further includes a rod portion and a base connected to one end of the rod portion axial along an axial direction;
the contact bracket further includes a top wall, and the two ends of the top wall along the third direction are integrally connected to one ends of the first side wall and the second side wall;
another ends of the first side wall and the second side wall are respectively clamped on the base.

According to some embodiments of the present disclosure, wherein the relay further includes a first magnetizer, the first magnetizer is arranged at one side of the movable contact assembly facing the static contact leading-out terminal;
the movable contact assembly includes a plurality of movable contact pieces and a plurality of second magnetizers, the plurality of movable contact pieces are arranged side by side along the third direction, the plurality of second magnetizers are fixedly connected to one sides of the plurality of movable contact pieces facing away from the static contact leading-out terminal in a one-to-one correspondence; each second magnetizer is configured to form a magnetic circuit with the first magnetizer;
two outermost second magnetizers among the plurality of second magnetizers respectively have the first side surface and the second side surface.

According to some embodiments of the present disclosure, wherein during a whole movement of the push rod assembly, the first anti-rotation piece always abuts between the first side wall and the first side surface, the second anti-rotation piece always abuts between the second side wall and the second side surface.

According to some embodiments of the present disclosure, wherein the first anti-rotation piece and/or the second anti-rotation piece is provided with a slot.

### BRIEF DESCRIPTION OF THE DRAWINGS

FIG. 1 is an exploded schematic diagram showing a relay according to an exemplary embodiment.

FIG. 2 is a schematic top view of the sealing unit according to an exemplary embodiment.

FIG. 3 is a cross-sectional view along line A-A in FIG. 2, wherein the movable contact assembly is not in contact with the static contact leading-out terminal.

FIG. 4 is a cross-sectional view along line B-B in FIG. 2, wherein the movable contact assembly is not in contact with the static contact leading-out terminal.

FIG. 5 is a cross-sectional view along line A-A in FIG. 2, wherein the movable contact assembly is in contact with the static contact leading-out terminal.

FIG. 6 is a cross-sectional view along line B-B in FIG. 2, wherein the movable contact assembly is in contact with the static contact leading-out terminal.

FIG. 7 is a schematic side view of the movable assembly according to the first exemplary embodiment.

FIG. 8 is a cross-sectional view along line C-C in FIG. 7.

FIG. 9 is a schematic side view of the movable assembly according to the second exemplary embodiment.

FIG. 10 is a cross-sectional view along line D-D in FIG. 9.

FIG. 11 is a schematic side view of the movable assembly according to the third exemplary embodiment.

FIG. 12 is a cross-sectional view along line E-E in FIG. 11.

FIG. 13 is a perspective diagram of the first anti-rotation piece in FIG. 11.

FIG. 14 is an enlarged view of X1 in FIG. 12.

FIG. 15 is a schematic side view of the movable assembly according to the fourth exemplary embodiment.

FIG. 16 is a cross-sectional view along line F-F in FIG. 15.

FIG. 17 is a perspective diagram of the anti-rotation structure in FIG. 15.

FIG. 18 and FIG. 19 are perspective views of the anti-rotation structure of other two examples of the movable assembly of the fourth exemplary embodiment.

FIG. 20 is a schematic side view of the movable assembly according to the fifth exemplary embodiment.

FIG. 21 is a cross-sectional view along line G-G in FIG. 20.

FIG. 22 is a perspective diagram of the anti-rotation structure in FIG. 20.

FIG. 23 and FIG. 24 are perspective views of the anti-rotation structure of other two examples of the movable assembly of the fifth exemplary embodiment.

FIG. 25 is a schematic side view of the movable assembly according to the sixth exemplary embodiment.

FIG. 26 is a cross-sectional view along line H-H in FIG. 25.

FIG. 27 is a perspective diagram of the anti-rotation structure in FIG. 25.

FIG. 28 is an enlarged view of X2 in FIG. 26.

FIG. 29 is a perspective diagram of the anti-rotation structure of another example of the movable assembly of the sixth exemplary embodiment.

FIG. 30 is a schematic side view of the movable assembly according to the seventh exemplary embodiment.

FIG. 31 is a perspective schematic diagram of the movable assembly according to the seventh exemplary embodiment.

FIG. 32 is a perspective diagram of the anti-rotation structure in FIG. 30.

FIG. 33 is a schematic side view of the movable assembly according to the eighth exemplary embodiment.

FIG. 34 is a cross-sectional view along line I-I in FIG. 33.

FIG. 35 is a perspective diagram of the anti-rotation structure in FIG. 33.

FIG. 36 is a schematic side view of the movable assembly according to the ninth exemplary embodiment.

FIG. 37 is a cross-sectional view along line J-J in FIG. 36.

FIG. 38 is a perspective diagram of the anti-rotation structure in FIG. 36.

FIG. 39 is a schematic side view of the movable assembly according to the tenth exemplary embodiment.

FIG. 40 is a cross-sectional view along line K-K in FIG. 39.

FIG. 41 is a perspective diagram of the anti-rotation structure in FIG. 39.

FIG. 42 is a perspective diagram showing an integral connection between the contact bracket and the anti-rotation structure in the movable assembly according to the eleventh exemplary embodiment.

FIG. 43 is a perspective diagram showing an integral connection between the contact bracket and the anti-rotation structure in the movable assembly according to the twelfth exemplary embodiment.

### DETAILED DESCRIPTION

Example embodiments will now be described more fully with reference to the accompanying drawings. Example embodiments may, however, be embodied in various forms and should not be construed as limited to the embodiments set forth herein; rather, these embodiments are provided so that this disclosure will be thorough and complete, and will fully convey the concepts of the examples.

The relay 1 of the embodiment of the present disclosure includes an outer shell 10, a coil unit 20, an arc extinguishing unit 30 and a sealing unit 40. The sealing unit 40 is arranged in the outer shell 10, and the top of the static contact leading-out terminal of the sealing unit 40 is exposed to the outer surface of the outer shell 10 through exposed holes 11a on the outer shell 10. The coil unit 20 and the arc extinguishing unit 30 are both arranged in the outer shell 10.

It is understood that the terms “include” and “have” and any of their variations used in the embodiments of the present disclosure are intended to cover non-exclusive inclusions. For example, a process, method, system, product, or apparatus that includes a series of steps or units is not limited to the listed steps or units, but may optionally include steps or units not listed, or may optionally include other inherent steps or components for these processes, methods, products, or apparatuses.

As an example, the outer shell 10 includes a first shell 11 and a second shell 12. The first shell 11 and the second shell 12 are connected to form a chamber for accommodating the coil unit 20, the arc extinguishing unit 30 and the sealing unit 40. In the embodiment of the present disclosure, the exposed holes 11a are provided in the first shell 11.

The arc extinguishing unit 30 is configured to extinguish the arc generated between the static contact leading-out terminal and the movable contact piece of the sealing unit 40.

As an example, the arc extinguishing unit 30 includes two arc extinguishing magnets. The arc extinguishing magnet 31 may be a permanent magnet, and each arc extinguishing magnet 31 may be substantially in a cuboid shape. Two arc extinguishing magnets 31 are respectively disposed on both sides of the sealing unit 40 and are disposed opposite to each other along the length direction of the movable contact piece.

By disposing two arc extinguishing magnets 31 opposite to each other, a magnetic field can be formed around the static contact leading-out terminal and the movable contact piece. Therefore, the arc generated between the static contact leading-out terminal and the movable contact piece is stretched in a direction away from each other by the action of the magnetic field, thereby achieving arc extinguishing.

The arc extinguishing unit 30 further includes two yoke clamps 32. Two yoke clamps 32 are arranged corresponding to the positions of two arc extinguishing magnets 31. In addition, two yoke clamps 32 surround the sealing unit 40 and two arc extinguishing magnets 31. By designing that the yoke clamps 32 surround the arc extinguishing magnet 31, it is possible to prevent the magnetic field generated by the arc extinguishing magnet 31 from spreading outward and affecting the arc extinguishing effect. The yoke clamp 32 is made of soft magnetic material. The soft magnetic material may include but is not limited to iron, cobalt, nickel, and alloys thereof, etc.

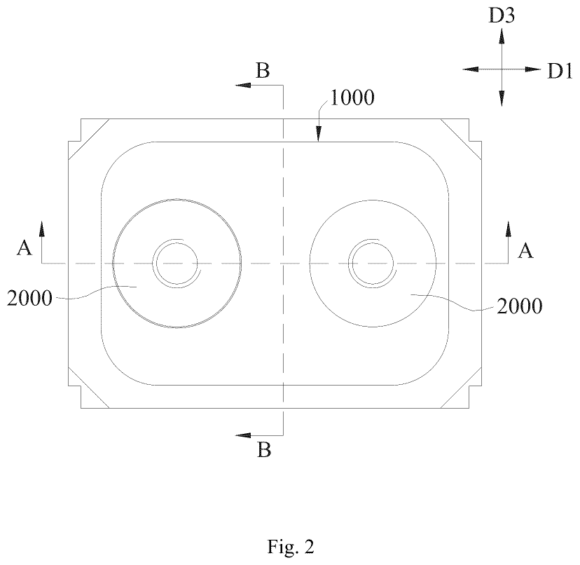

As shown in FIG. 2 to FIG. 4, the sealing unit 40 includes a contact container 1000, a pair of static contact leading-out terminals 2000, a movable assembly 3000 and a magnetic circuit part 4000.

It should be noted that the contact container 1000 is a stationary component, which is used to accommodate the contact group and is mainly a housing with a chamber. In addition, the contact container 1000 can be composed of multiple components connected in a predetermined assembly manner.

The contact container 1000 has a contact chamber 1001 therein. The contact container 1000 may include an insulating cover 1100 and a yoke plate 1200. The insulating cover 1100 is covered on one side surface of the yoke plate 1200. The insulating cover 1100 and the yoke plate 1200 together enclose the contact chamber 1001.

The insulating cover 1100 includes a ceramic cover 1110 and a frame piece 1120. The ceramic cover 1110 is connected to the yoke plate 1200 through the frame piece 1120. The frame piece 1120 may be a metal piece of an annular structure, such as an iron-nickel alloy, and one end of the frame piece 1120 is connected to an opening edge of the ceramic cover 1110, for example, by laser welding, brazing, resistance welding, gluing, etc. The other end of the frame piece 1120 is connected to the yoke plate 1200, which may also be laser welding, brazing, resistance welding, gluing, etc. The frame piece 1120 is arranged between the ceramic cover 1110 and the yoke plate 1200, which can facilitate the connection between the ceramic cover 1110 and the yoke plate 1200.

The contact container 1000 also has a pair of first through holes 1002, the first through holes 1002 are communicated with the contact chamber 1001. The first through holes 1002 are used for the static contact leading-out terminal 2000 to pass through. In the embodiment of the present disclosure, the first through holes 1002 are opened on the ceramic cover 1110.

The pair of static contact leading-out terminals 2000 are connected to the ceramic cover 1110 of the contact container 1000, and at least a portion of each static contact leading-out terminal 2000 is located in the contact chamber 1001. One of the pair of static contact leading-out terminals 2000 is used as a terminal for current to flow in and the other is used as a terminal for current to flow out.

The pair of static contact leading-out terminals 2000 are respectively disposed in the pair of first through holes 1002 and connected to the ceramic cover 1110, for example, by welding.

The bottom of static contact leading-out terminal 2000 serves as a static contact, and the static contact may be integrally or separately arranged at the bottom of the static contact leading-out terminal 2000.

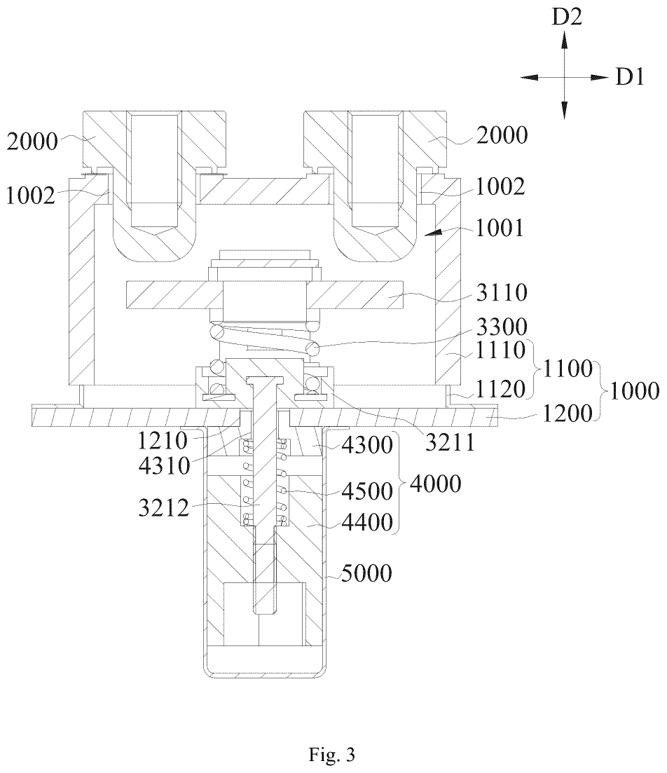

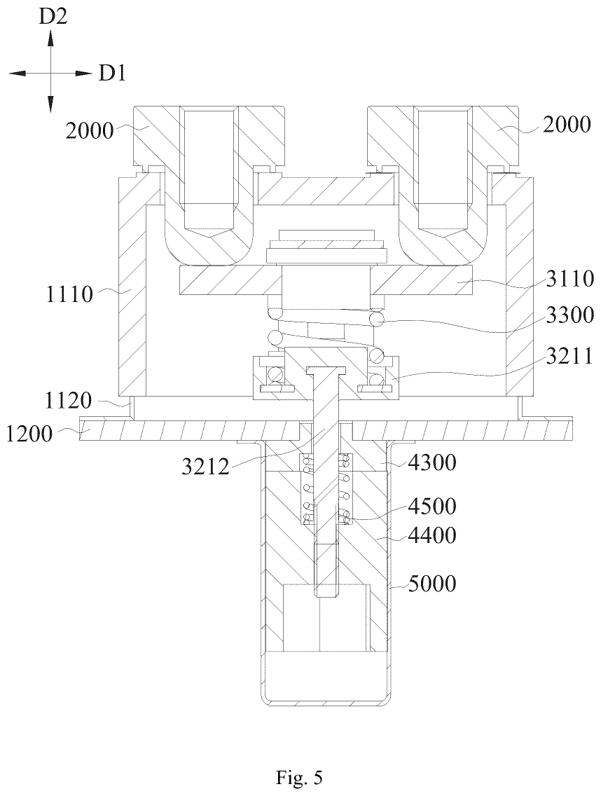

As shown in FIGS. 3 to 6, the movable assembly 3000 includes a movable contact assembly 3100, a push rod assembly 3200 and an elastic assembly 3300. The movable contact assembly 3100 is provided in the insulating cover 1100 and is mounted on the push rod assembly 3200 through the elastic assembly 3300. Both ends of the movable contact assembly 3100 along a first direction D1 are used to contact with or separate from the pair of static contact leading-out terminals 2000 respectively. Wherein the first direction D1 is an arrangement of the pair of static contact leading-out terminals 2000.

It should be noted that if one pair of static contact leading-out terminals 2000 and one movable contact assembly 3100 are regarded as a set, and the relay in the embodiment of the present disclosure may include multiple sets.

The movable contact assembly 3100 may include a movable contact piece 3110. Wherein both ends of the movable contact piece 3110 along the first direction D1 are respectively used to contact with or separate from the pair of static contact leading-out terminals 2000.

It can be understood that the number of the movable contact piece 3110 can be one or more.

Each movable contact piece 3110 may include a movable piece body and movable contacts disposed at both ends of the movable piece body. The movable contact can be a separate part and connected to the movable piece body. Of course, the movable contact can also be integrally formed on the movable piece body.

In the embodiment of the present disclosure, the movable contact assembly 3100 includes two movable contact pieces 3110 arranged side by side. One ends of the two movable contact pieces 3110 are configured to contact with or separate from the static contacts of one of the static contact leading-out terminals 2000, and the other ends of the two movable contact pieces 3110 are configured to contact with or separate from the static contacts of the other one of the static contact leading-out terminals 2000. In other words, one ends of the two movable contact pieces 3110 forms two touch points with one of the static contact leading-out terminals 2000, and the other ends of the two movable contact pieces 3110 form two touch points with the other one of the static contact leading-out terminals 2000.

In other embodiments, the number of the movable contact pieces 3110 can also be one, three, four, five, etc.

It is understood that the movable contact assembly 3100 includes a plurality of movable contact pieces 3110. Two ends of the plurality of movable contact pieces 3110 along the first direction D1 are contact with or separate from the pair of static contact leading-out terminals. Due to the plurality of movable contact pieces 3110 will not restrict each other, so that a reliable parallel circuit is formed after two ends of the plurality of movable contact pieces 3110 along the first direction D1 are in contact with the pair of static contact leading-out terminals 2000. The number of touch points formed by the plurality of movable contact pieces 3110 and one static contact leading-out terminal 2000 is greater than or equal to two, achieving a shunting effect. In addition, according to the principle that the magnitude of the electric repulsion force is proportional to the square of the current, the magnitude of the electric repulsion force of each contact is significantly reduced, which is conducive to the improvement of anti-short circuit ability and the reliability of the relay.

Furthermore, the movable contact assembly 3100 may further include a second magnetizer 6200, and the second magnetizer 6200 is fixedly connected to one side of the movable contact piece 3110 facing away from the static contact leading-out terminal 2000. The function of the second magnetizer 6200 will be described below.

The number of movable contact piece 3110 and the number of the second magnetizer 6200 in the movable contact assembly 3100 are equal. Specifically, when the number of the movable contact piece 3110 is one, the number of the second magnetizer 6200 is also one; when the number of the movable contact piece 3110 is a plurality (including two), the number of the second magnetizer 6200 is also a plurality. The plurality of second magnetizers 6200 are fixedly connected to one side of the plurality of movable contact pieces facing away from the static contact leading-out terminal 2000 in a one-to-one correspondence.

As shown in FIGS. 3 to 6, the moving direction of the movable contact piece 3110 is defined as the second direction D2, and the direction perpendicular to the first direction D1 and the second direction D2 is defined as the third direction D3. The push rod assembly 3200 includes a push rod 3210, a contact bracket 3220 and a stop wall 3230. The push rod 3210 includes a base 3211 and a rod portion 3212, wherein the base 3211 is connected to one end of the rod portion 3212 along an axial direction. The contact bracket 3220 includes a bottom wall 3221, a first side wall 3222a and a second side wall 3222b, the first side wall 3222a and the second side wall 3222b are arranged opposite to each other along the third direction D3. One ends of the first side wall 3222a and the second side wall 3222b are respectively connected to both sides of the bottom wall 3221 along the third direction D3, and the other ends of the first side wall 3222a and the second side wall 3222b are connected to the stop wall 3230. The stop wall 3230 is arranged at one side of the movable contact assembly 3100 facing the static contact leading-out terminal 2000. The movable contact assembly 3100 is installed through the elastic assembly 3300 in a space enclosed by the contact bracket 3220 and the base 3211.

The first side wall 3222a has a first opening 3228, and the second side wall 3222b has a second opening 3229. Both ends of the stop wall 3230 along the third direction D3 are respectively clamped into the first opening 3228 and the second opening 3229.

The contact bracket 3220, the rod portion 3212 and the base 3211 are connected by injection molding, and the base 3211 wraps the bottom wall 3221 and one end of the first side wall 3222a and one end of the second side wall 3222b.

In another embodiment, both ends of the stop wall 3230 may be integrally connected to the first side wall 3222a and the second side wall 3222b respectively.

The elastic assembly 3300 is disposed between the movable contact assembly 3100 and the base 3211, and is used to apply an elastic force to the movable contact assembly 3100 to move toward the stop wall 3230, so as to provide a contact pressure.

It can be understood that the elastic assembly 3300 can be used to flexibly support the movable contact assembly 3100 and provide the contact pressure.

When the movable contact piece 3110 is plural in number, the plurality of movable contact pieces 3110 are arranged side by side along the third direction D3.

Referring back to FIGS. 3 to 6, the yoke plate 1200 has a second through hole 1210, which penetrates two opposite sides of the yoke plate 1200 along the thickness direction of the yoke plate 1200, and the second through hole 1210 is communicated with the contact chamber 1001 of the contact container 1000. The rod portion 3212 is movably disposed in the second through hole 1210 in the axial direction. The base 3211 at one axial end of the rod portion 3212 is disposed in the contact chamber 1001.

The sealing unit 40 further includes a metal cover 5000. The metal cover 5000 is connected to the side of the yoke plate 1200 facing away from the insulating cover 1100, and the metal cover 5000 covers the second through hole 1210 on the yoke plate 1200. The metal cover 5000 and the yoke plate 1200 enclose a chamber for accommodating the static iron core 4300 and the movable iron core 4400 of the magnetic circuit part 4000.

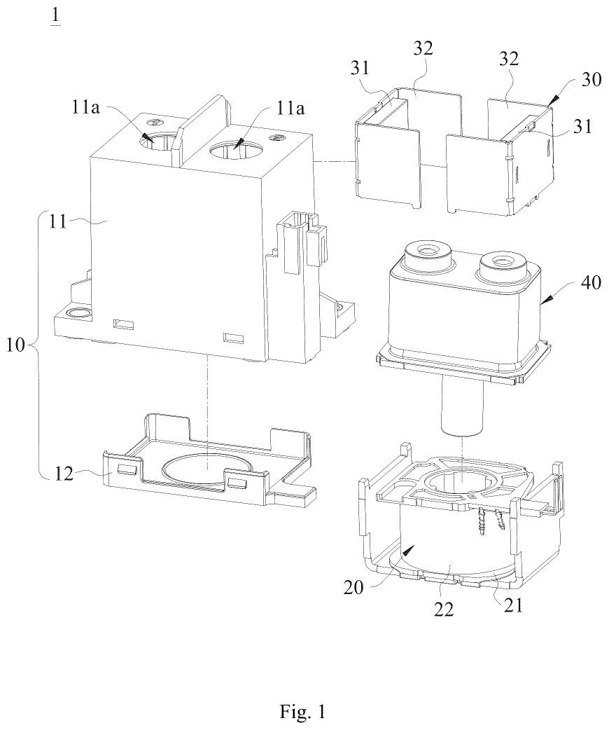

Referring back to FIG. 1, the coil unit 20 includes a bobbin 21 and a coil 22. The bobbin 21 is in a hollow cylindrical shape and is made of insulating material. The metal cover 5000 is inserted into the bobbin 21. The coil 22 surrounds the bobbin 21.

As shown in FIGS. 3 to 6, the magnetic circuit part 4000 includes a static iron core 4300, a movable iron core 4400 and a reset piece 4500. The static iron core 4300 is fixedly arranged in the metal cover 5000, and a part of the static iron core 4300 extends into the second through hole 1210. The static iron core 4300 has a penetrating hole 4310 arranged corresponding to the position of the second through hole 1210, and is used for the rod portion 3212 to be inserted therein. The movable iron core 4400 is movably arranged in the metal cover 5000, and is arranged opposite to the static iron core 4300 along the axial direction of the rod portion 3212. The movable iron core 4400 is connected to the rod portion 3212 and is used to be attracted by the static iron core 4300 when the coil 22 is energized. The movable iron core 4400 and the rod portion 3212 can be connected by threading, riveting, welding or other methods.

The reset piece 4500 is located inside the metal cover 5000 and is disposed between the static iron core 4300 and the movable iron core 4400, and is used to reset the movable iron core 4400 when the coil 22 is powered off. The reset piece 4500 may be a spring and is sleeved outside the rod portion 3212.

It should be noted that when the coil 22 is energized, the static iron core 4300 attracts the movable iron core 4400 to move upward, and the movable iron core 4400 can drive the push rod assembly 3200 to move upward through the rod portion 3212. When the movable contact piece 3110 contacts the static contact leading-out terminal 2000, the movable contact piece 3110 is stopped by the static contact leading-out terminal 2000, while the rod portion 3212 and the base 3211 will continue to move upward until the over-travel is completed.

During the over-travel process, the base 3211 compresses the elastic assembly 3300. After being compressed, the elastic assembly 3300 can provide the elastic force to the movable contact assembly 3100, to provide the contact pressure.

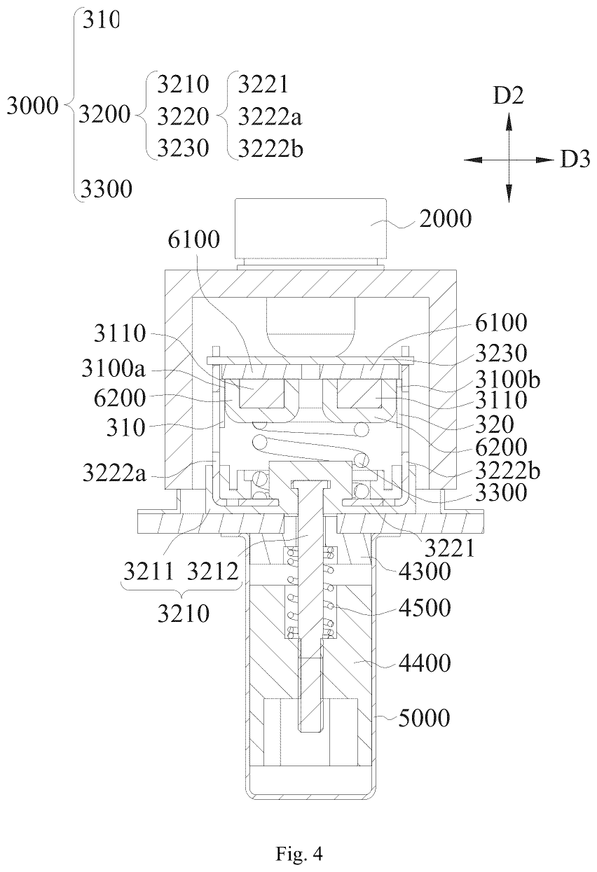

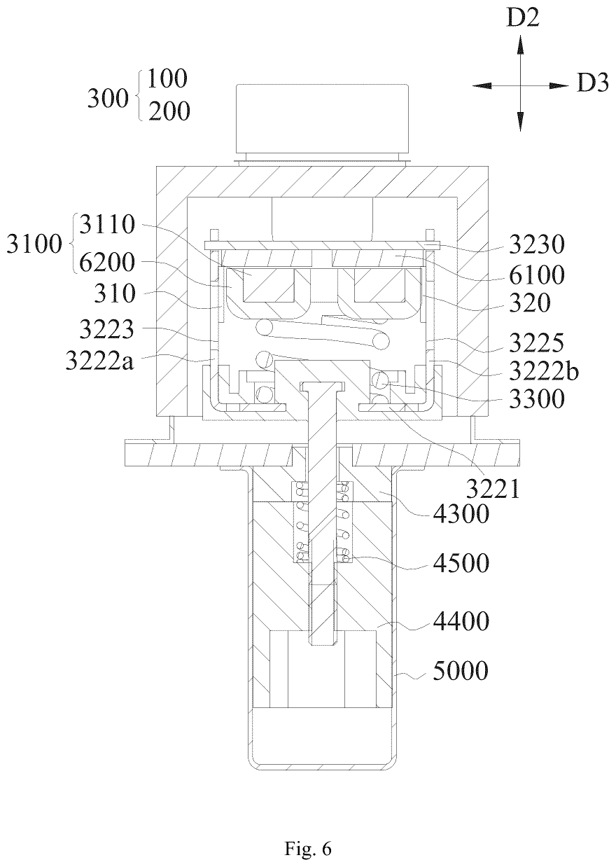

As shown in FIGS. 4 and 6, the relay 1 further includes a first magnetizer 6100, the first magnetizer 6100 is fixedly connected to one side surface of the stop wall 3230 facing the movable contact assembly 3100, and the first magnetizer 6100 is located at a side of the movable contact assembly 3100 facing the static contact leading-out terminal 2000.

It can be understood that when the movable contact piece 3110 is energized, the first magnetizer 6100 is magnetized, thereby forming a suction force on the movable contact piece 3110 in the contact closing direction, and the suction force can resist the electric repulsion force generated by the short circuit current between the movable contact piece 3110 and the static contact leading-out terminal 2000, thereby preventing the movable contact piece 3110 and the static contact leading-out terminal 2000 from bouncing off, thereby achieving the purpose of anti-short circuit.

When the movable contact assembly 3100 includes a plurality of movable contact pieces 3110 arranged side by side, the number of the first magnetizers 6100 may be plural, and the number of the first magnetizers 6100 corresponds to the number of the movable contact pieces 3110, and the plurality of first magnetizers 6100 are respectively located at one side of the plurality of movable contact pieces 3110 facing the static contact leading-out terminal 2000.

Of course, in other embodiments, when the movable contact assembly 3100 includes a plurality of movable contact pieces arranged side by side, the number of the first magnetizer 6100 may be one, and the first magnetizer 6100 spans the plurality of movable contact pieces 3110 in the third direction D3.

Furthermore, when the movable contact assembly 3100 includes a movable contact piece 3110 and a second magnetizer 6200, the second magnetizer 6200 is fixedly connected to one side of the movable contact piece 3110 facing away from the static contact leading-out terminal 2000. The second magnetizer 6200 is used to form a magnetic circuit with the first magnetizer 6100.

The number of the second magnetizers 6200 corresponds to the number of the movable contact pieces 3110. In the embodiment of the present disclosure, the number of the second magnetizers 6200 is two, but not limited thereto. The two second magnetizers 6200 are respectively fixedly connected to one sides of the two movable contact pieces 3110 facing away from the static contact leading-out terminal 2000.

When the two ends of the movable contact piece 3110 are respectively in contact with the pair of static contact leading-out terminals, a magnetic circuit around the movable contact piece 3110 between the first magnetizer 6100 and the second magnetizer 6200 is formed when a current flow through the movable contact piece 3110. When a short circuit current flows through the movable contact piece 3110, a suction force along the contact pressure direction is generated between the first magnetizer 6100 and the second magnetizer 6200, and the suction force can resist the electric repulsion force generated by the short circuit current between the movable contact piece 3110 and the static contact leading-out terminal 2000, thereby preventing the movable contact piece 3110 and the static contact leading-out terminal 2000 from bouncing off.

It is understandable that the first magnetizer 6100 and the second magnetizer 6200 may be a straight-line structure or a U-shaped structure. The first magnetizer 6100 and the second magnetizer 6200 may be made of soft magnetic materials such as iron, cobalt, nickel, and alloys thereof.

In another embodiment, the first magnetizer 6100 may not be installed on the stop wall 3230 of the push rod assembly 3200, but may be fixed relative to the contact container 1000. In this way, the anti-short circuit suction force is transferred to the contact container 1000. Since the contact container 1000 is a stationary component, there is no need for excessive holding force of the coil, thereby reducing the power consumption of the coil of the relay 1 and the volume of the relay 1, thereby improving the anti-short circuit ability.

In a specific embodiment, the first magnetizer 6100 can be fixedly connected to the ceramic cover 1110 of the contact container 1000.

In another specific embodiment, the first magnetizer 6100 is fixed in the contact container 1000 through a fixing bracket (not shown in the figure). Specifically, the fixing bracket is disposed in the contact container 1000 and is fixedly connected to the yoke plate 1200, and the first magnetizer 6100 is fixedly connected to the fixing bracket.

In another embodiment, the distance between the first magnetizer 6100 and the second magnetizer 6200 can be designed to be variable. Specifically, the distance between the first magnetizer 6100 and the second magnetizer 6200 can be adjusted according to the magnitude of the current value, thereby changing the magnitude of the magnetic attraction generated between the first magnetizer 6100 and the second magnetizer 6200, thus meeting the requirements of short circuit resistance, as well as overload disconnection.

Optionally, the first magnetizer 6100 may include a plurality of magnetic conductive sheets stacked with each other. It is understood that by increasing the number of thinner magnetic conductive sheets, the overall thickness of the first magnetizer 6100 may be increased. On the one hand, the magnetic conductive sheets are thinner and can be made of thin strips, so the material cost is low and easy to operate. On the other hand, the number of the magnetic conductive sheets can be flexibly adjusted according to the size of the short circuit current.

As shown in FIGS. 4 and 6, the movable contact assembly 3100 has a first side surface 3100a and a second side surface 3100b that are disposed opposite to each other along the third direction D3. The first side surface 3100a corresponds to the first side wall 3222a of the contact bracket 3220, and the second side surface 3100b corresponds to the second side wall 3222b of the contact bracket 3220.

When the movable contact assembly 3100 includes a plurality of movable contact pieces 3110 and a plurality of second magnetizers 6200, two outermost second magnetizers 6200 among the plurality of second magnetizers 6200 respectively have the first side surface 3100a and the second side surface 3100b.

In other embodiments, when the movable contact assembly 3100 includes only a plurality of movable contact pieces 3110, two outermost movable contact pieces 3110 in the plurality of movable contact pieces 3110 have the first side surface 3100a and the second side surface 3100b respectively.

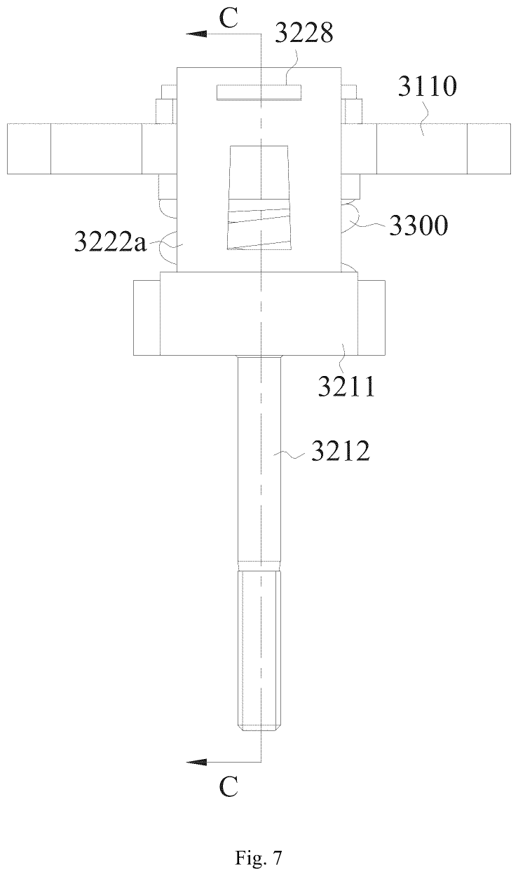

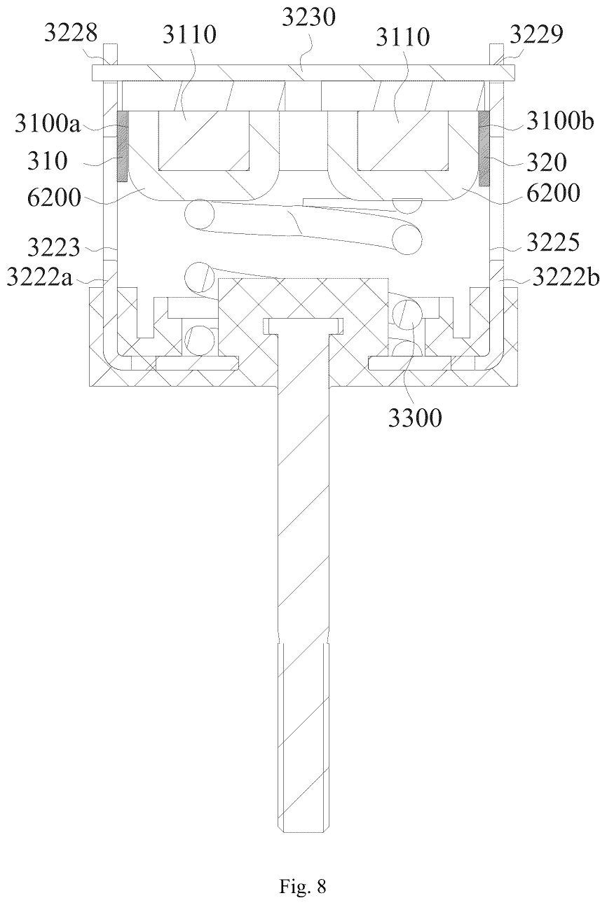

As shown in FIGS. 7 and 8, the relay 1 of the embodiment of the present disclosure further includes an anti-rotation structure 300. The anti-rotation structure 300 includes a first anti-rotation piece 310 and a second anti-rotation piece 320, the first anti-rotation piece 310 is disposed between the first side wall 3222a and the first side surface 3100a, and the second anti-rotation piece 320 is disposed between the second side wall 3222b and the second side surface 3100b.

In the relay 1 of the embodiment of the present disclosure, the first anti-rotation piece 310 is arranged between the first side wall 3222a and the first side surface 3100a, and the second anti-rotation piece 320 is arranged between the second side wall 3222b and the second side surface 3100b, so that when the movable contact assembly 3100 rotates relative to the axis of the push rod, the first anti-rotation piece 310 and/or the second anti-rotation piece 320 can abut against the movable contact assembly 3100 along the third direction D3, so that the movable contact assembly 3100 is clamped between the first anti-rotation piece 310 and the second anti-rotation piece 320, thereby metal noise caused by contact friction between the movable contact assembly 3100 and the first side wall 3222a and the second side wall 3222b is avoided, and the risk of metal particles generated by friction between the movable contact assembly 3100 and the contact bracket 3220 is significantly reduced, and the working reliability of the relay 1 is ensured, and the rotation amplitude of the movable contact assembly 3100 relative to the push rod around the axis of the push rod is reduced. Further, the consistency of the contact position between the movable contact assembly 3100 and the static contact leading-out terminal 2000 is ensured, and the stability of the contact resistance is ensured.

As shown in FIG. 8, in the first embodiment of the present disclosure, the first anti-rotation piece 310 and the second anti-rotation piece 320 are both sheet structures made of flexible materials. The first side wall 3222a has a first inner side surface 3223 facing the movable contact assembly 3100, and the first anti-rotation piece 310 is attached to the first inner side surface 3223 or the first side surface 3100a. The second side wall 3222b has a second inner side surface 3225 facing the movable contact assembly 3100, and the second anti-rotation piece 320 is attached to the second inner side surface 3225 or the second side surface 3100b.

In one embodiment, the flexible material may be a non-metallic material, such as rubber or wear-resistant plastic, but is not limited thereto.

The first anti-rotation piece 310 can be attached to the first inner side surface 3223 or the first side surface 3100a by welding, bonding or the like, and the second anti-rotation piece 320 can be attached to the second inner side surface 3225 or the second side surface 3100b by welding, bonding or the like.

In the embodiment of the present disclosure, the first anti-rotation piece 310 and the second anti-rotation piece 320 are both made of flexible materials, which can reduce the wear of the first anti-rotation piece 310 and the second anti-rotation piece 320 on the movable contact assembly 3100, and reduce the friction between the first anti-rotation piece 310 and the first side surface 3100a and between the second anti-rotation piece 320 and the second side surface 3100b, so as to avoid affecting the over-travel process. In addition, the flexible material can also reduce the deflection force of the movable contact assembly 3100 relative to the contact bracket 3220, thereby reducing the rotation amplitude of the movable contact assembly 3100, and reducing the friction resistance and friction noise between the movable contact assembly 3100 and the contact bracket 3220.

Of course, in other embodiments, the first anti-rotation piece 310 may also be connected to the first side surface 3100a, and the second anti-rotation piece 320 may also be connected to the second side surface 3100b.

Furthermore, during the whole movement of the push rod assembly 3200, the first anti-rotation piece 310 always abuts between the first side wall 3222a and the first side surface 3100a, and the second anti-rotation piece 320 always abuts between the second side wall 3222b and the second side surface 3100b. Specifically, before the movable contact piece 3110 comes into contact with the static contact leading-out terminal 2000, the first anti-rotation piece 310 abuts between the first side wall 3222a and the first side surface 3100a, and the second anti-rotation piece 320 abuts between the second side wall 3222b and the second side surface 3100b; in the initial stage of over-travel (i.e., when the movable contact piece 3110 just comes into contact with the static contact leading-out terminal 2000), the first anti-rotation piece 310 abuts between the first side wall 3222a and the first side surface 3100a, and the second anti-rotation piece 320 abuts between the second side wall 3222b and the second side surface 3100b; in the end stage of over-travel (i.e., when the movable iron core 4400 comes into contact with the static iron core 4300), The first anti-rotation piece 310 still abuts between the first side wall 3222a and the first side surface 3100a, and the second anti-rotation piece 320 still abuts between the second side wall 3222b and the second side surface 3100b; and, at any position between the initial stage of over-travel and the end stage of over-travel, the first anti-rotation piece 310 also abuts between the first side wall 3222a and the first side surface 3100a, and the second anti-rotation piece 320 also abuts between the second side wall 3222b and the second side surface 3100b. In this way, the movable contact assembly 3100 can remain stable throughout the whole process of the movement of the movable assembly 3000, thereby reducing the rotation amplitude of the movable contact assembly 3100 relative to the push rod around the axis of the push rod.

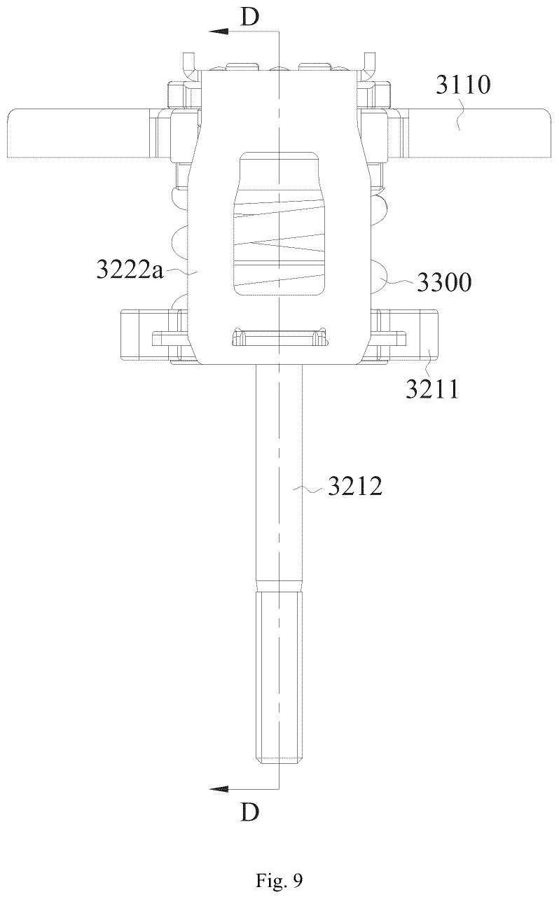

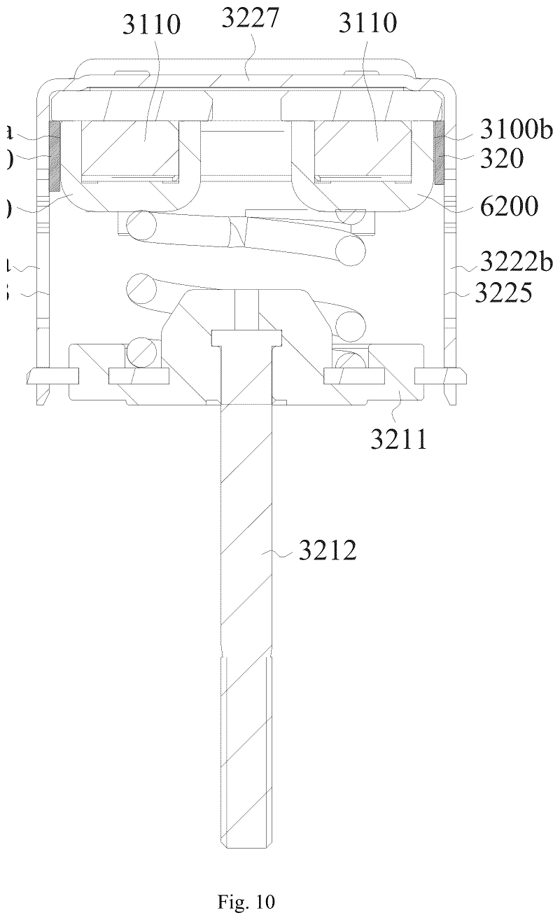

As shown in FIG. 9 and FIG. 10, the movable assembly 3000 of the second embodiment of the present disclosure is similar to the movable assembly 3000 of the first embodiment and is not described in detail. The difference is that:

The contact bracket 3220 of the push rod assembly 3200 is an inverted U-shape, including a top wall 3227 and two side walls. (the two side walls are respectively equivalent to the first side wall 3222a and the second side wall 3222b of the first embodiment described above), one ends of the two side walls are respectively connected to the two side edges of the top wall 3227 along the third direction D3, and the other ends of the two side walls are respectively clamped on the base 3211.

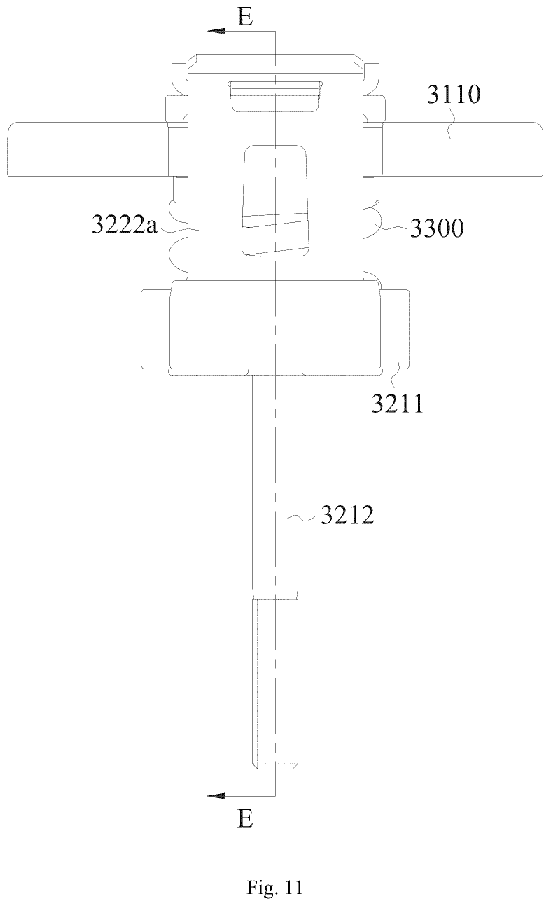

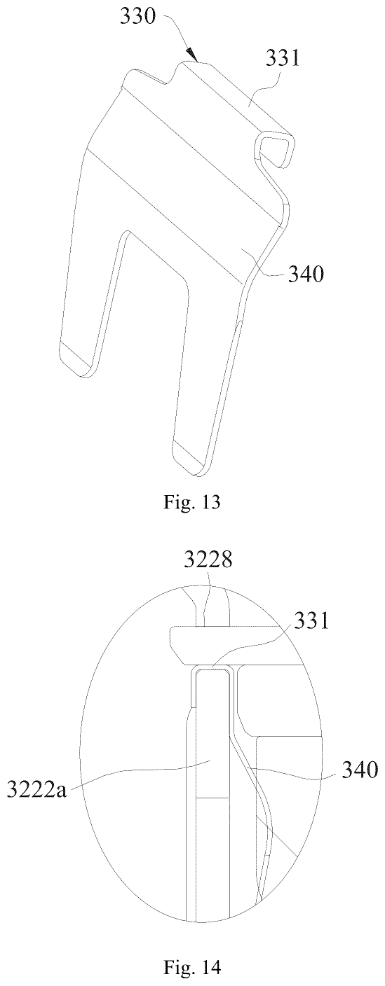

As shown in FIG. 11 to FIG. 14, the movable assembly 3000 of the third embodiment of the present disclosure is similar to the movable assembly 3000 of the first embodiment and is not described in detail. The difference is that:

The first anti-rotation piece 310 and the second anti-rotation piece 320 are both elastic pieces. The first anti-rotation piece 310 is compressed between the first side wall 3222a and the first side surface 3100a of the movable contact assembly 3100 to provide a first elastic force to the movable contact assembly 3100. The second anti-rotation piece 320 is compressed between the second side wall 3222b and the second side surface 3100b of the movable contact assembly 3100 to provide a second elastic force to the movable contact assembly 3100. The first elastic force is opposite to the second elastic force.

In the embodiment of the present disclosure, the first anti-rotation piece 310 and the second anti-rotation piece 320 are both elastic pieces. The elastic force provided by the elastic pieces can absorb the deflection of the movable contact assembly 3100, reduce the deflection force between the movable contact assembly 3100 and the first side wall 3222a and the second side wall 3222b of the contact bracket 3220, and reduce the friction resistance and friction noise between the movable contact assembly 3100 and the contact bracket 3220.

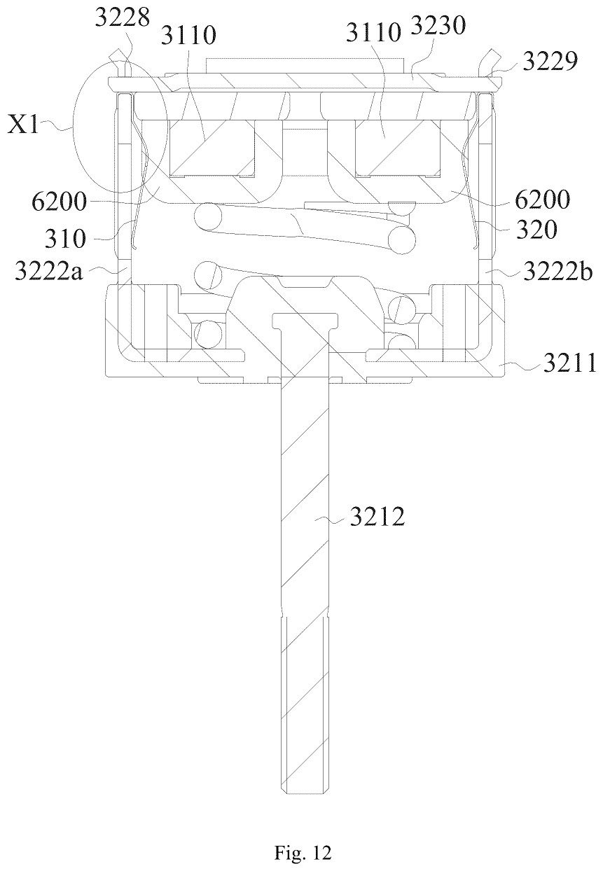

As shown in FIGS. 12 to 14, the first anti-rotation piece 310 and the second anti-rotation piece 320 both include the connection portion 330 and the elastic sheet portion 340; two connection portions 330 are respectively connected to the first side wall 3222a and the second side wall 3222b, and two elastic sheet portions 340 respectively extend from two connection portions 330 in a direction away from the static contact leading-out terminal 2000; the two elastic sheet portions 340 are used to provide the first elastic force and the second elastic force to the movable contact assembly 3100, respectively.

The connection portion 330 includes a hanging hook 331, two hanging hooks 331 are hung on the lower edge of the first opening 3228 and the lower edge of the second opening 3229 respectively.

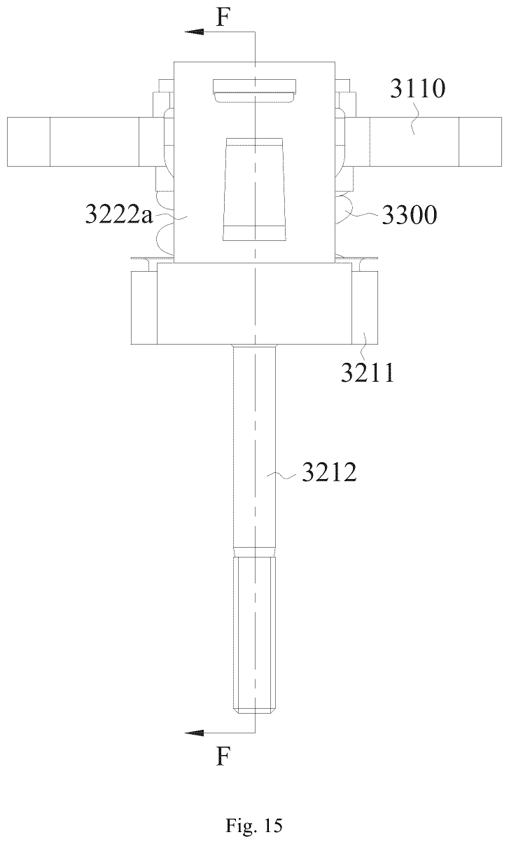

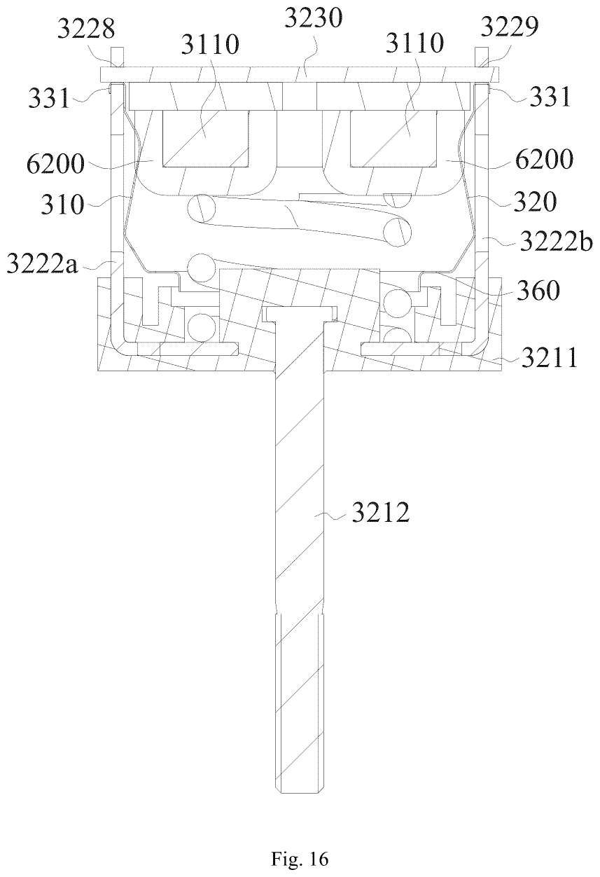

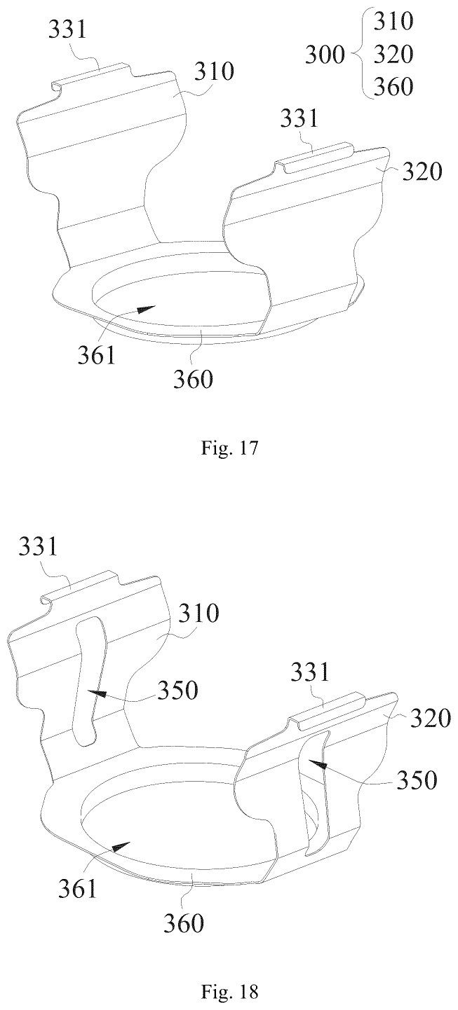

As shown in FIGS. 15 to 17, the movable assembly 3000 of the fourth embodiment of the present disclosure is similar to the movable assembly 3000 of the third embodiment and is not described in detail. The difference between the movable assembly 3000 and the third embodiment is as follows:

The anti-rotation structure 300 further includes a connection piece 360. One end of the first anti-rotation piece 310 and one end of the second anti-rotation piece 320 are integrally connected to two ends of the connection piece 360 along the third direction D3. The connection piece 360 has a center hole 361. The elastic assembly 3300 passes through the center hole 361.

In the embodiment of the present disclosure, the connection piece 360 is integrally connected to the first anti-rotation piece 310 and the second anti-rotation piece 320, thereby improving the structural strength of the anti-rotation structure 300 and preventing the first anti-rotation piece 310 and the second anti-rotation piece 320 from shaking.

As shown in FIG. 18, in another embodiment, slots 350 are provided on both the first anti-rotation piece 310 and the second anti-rotation piece 320 of the anti-rotation structure 300. The extending direction of the slot 350 is substantially parallel to the second direction D2.

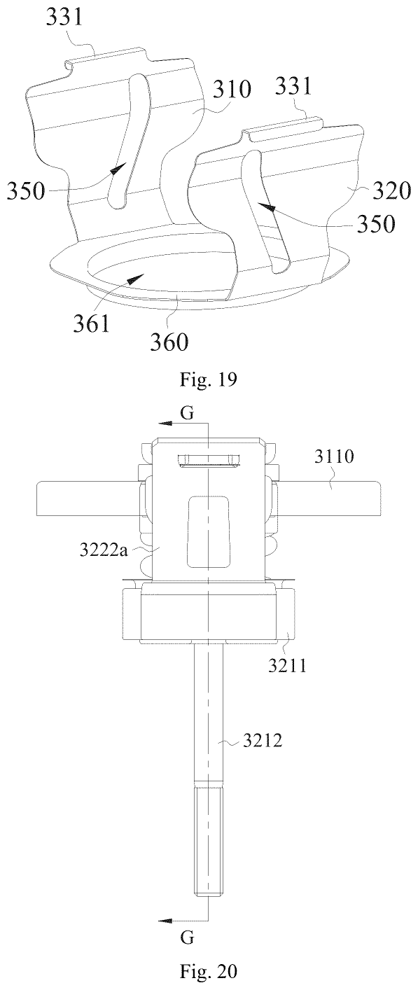

As shown in FIG. 19, in another embodiment, slots 350 are provided on both the first anti-rotation piece 310 and the second anti-rotation piece 320 of the anti-rotation structure 300. The extending direction of the slot 350 is inclined relative to the second direction D2.

In the embodiment of the present disclosure, the first anti-rotation piece 310 and the second anti-rotation piece 320 are provided with the slots 350, thereby improving the flexibility of the first anti-rotation piece 310 and the second anti-rotation piece 320. On the one hand, the elastic force of the first anti-rotation piece 310 and the second anti-rotation piece 320 is reduced so as to better absorb the deflection force of the movable contact assembly 3100. On the other hand, the rigidity of the first anti-rotation piece 310 and the second anti-rotation piece 320 is increased to avoid wear on the movable contact assembly 3100.

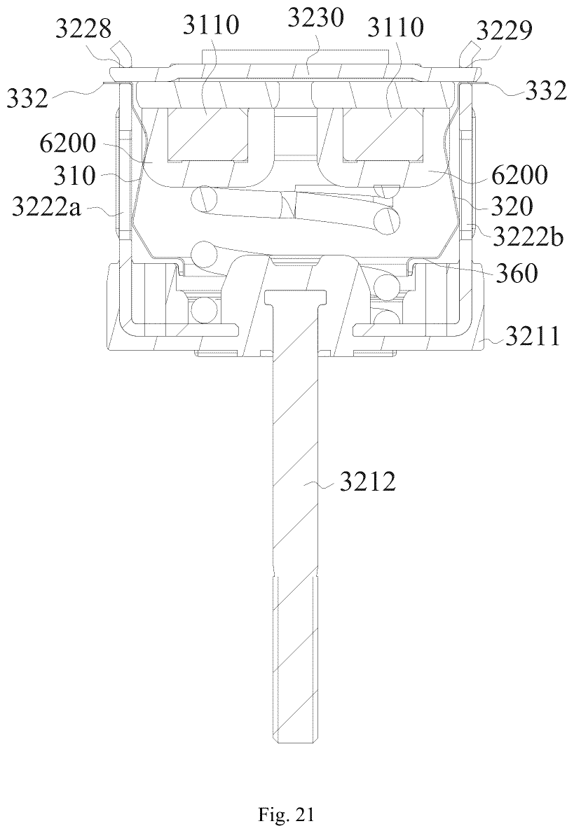

As shown in FIG. 20 to FIG. 22, the movable assembly 3000 of the fifth embodiment of the present disclosure is similar to the movable assembly 3000 of the fourth embodiment and is not described in detail. The difference is that:

Each connection portion 330 includes a clamping structure 332, and the clamping structures 332 of two connection portions 330 are respectively clamped in the first opening 3228 and the second opening 3229.

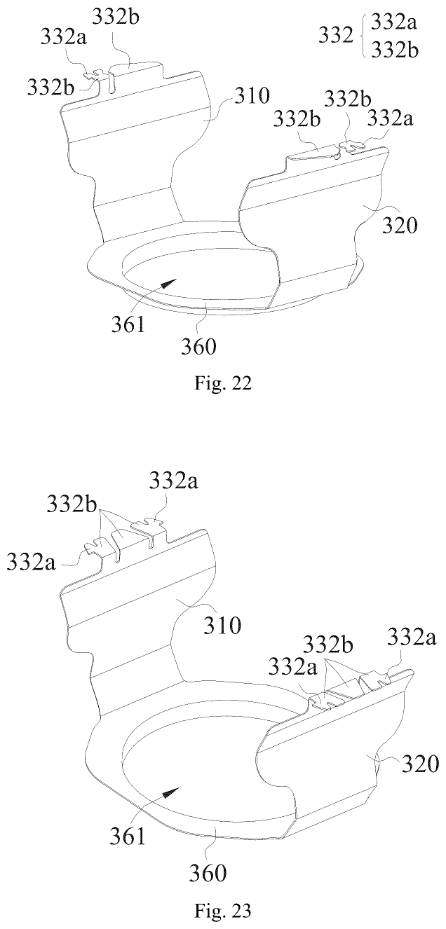

As shown in FIG. 22, the clamping structure 332 includes two connection sheets 332b, and the connection sheets 332b are connected to the elastic sheet portion 340. A clamping hook 332a is provided on one of the connection sheets 332b.

As shown in FIG. 23, the clamping structure 332 includes three connection sheets 332b arranged in sequence along the third direction D3, there is a gap between two adjacent connection sheets 332b. Wherein the two connection sheets 332b located on the outermost sides are each provided with one clamping hook 332a.

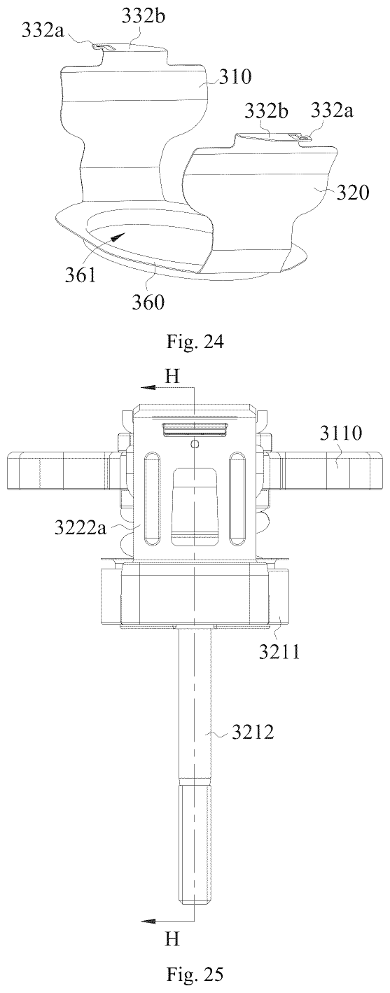

As shown in FIG. 24, the clamping structure 332 includes one connection sheet 332b, one end of the connection sheet 332b along the third direction D3 is provided with the clamping hook 332a.

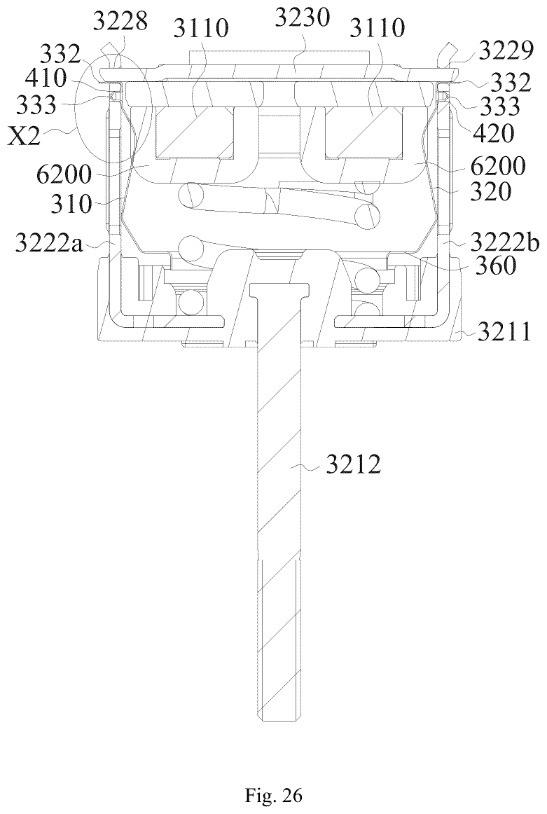

As shown in FIG. 25 to FIG. 28, the movable assembly 3000 of the sixth embodiment of the present disclosure is similar to the movable assembly 3000 of the fifth embodiment and is not described in detail. The difference is that:

The clamping structure 332 is a sheet-like structure, and two clamping structures 332 are respectively clamped in the first opening 3228 and the second opening 3229.

The first side wall 3222a is further provided with a first connecting hole 410, and the second side wall 3222b is further provided with a second connecting hole 420. Each connection portion 330 further includes a protrusion 333, and the protrusions 333 of two connection portions 330 extend into the first connecting hole 410 and the second connecting hole 420, respectively, and are respectively interference-fitted with the first connecting hole 410 and the second connecting hole 420.

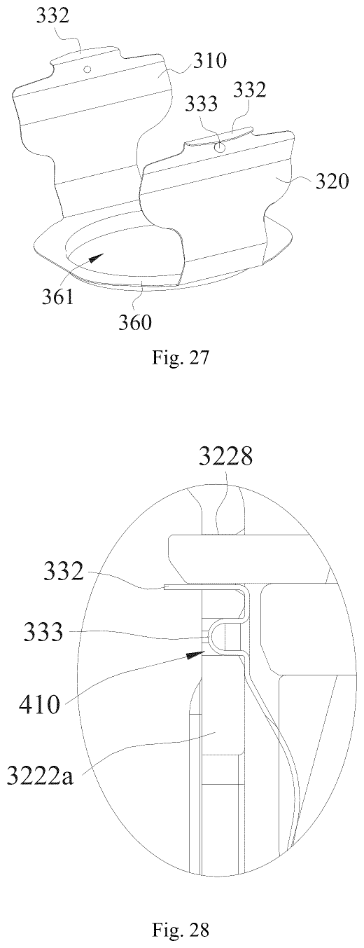

As shown in FIG. 27, the cross-sectional shape of the protrusion 333 is circular.

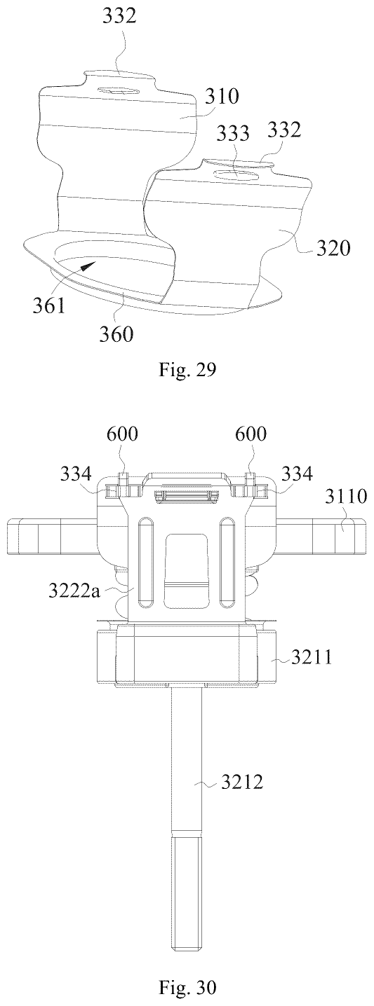

As shown in FIG. 29, in another embodiment, the cross-sectional shape of the protrusion 333 may also be an ellipse. Of course, in other embodiments, the cross-sectional shape of the protrusion 333 may also be a rectangle, a triangle, or other shapes.

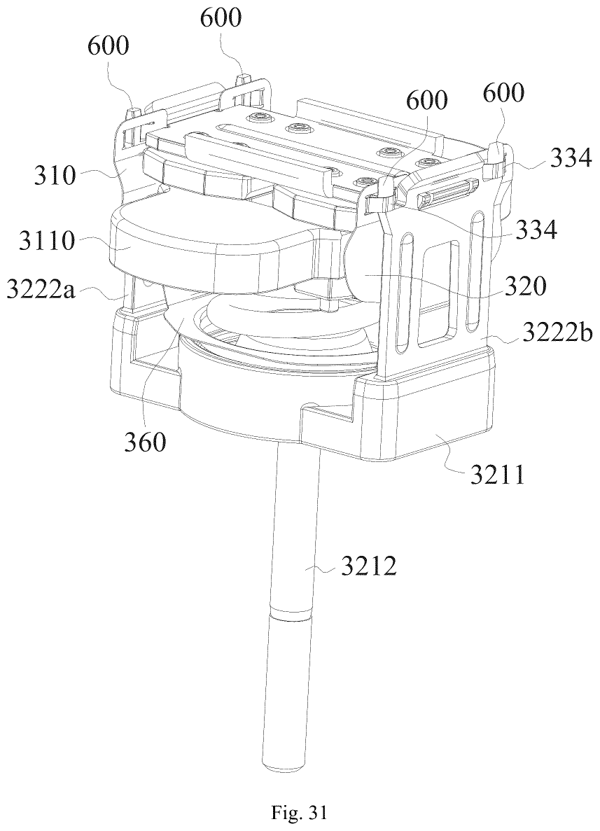

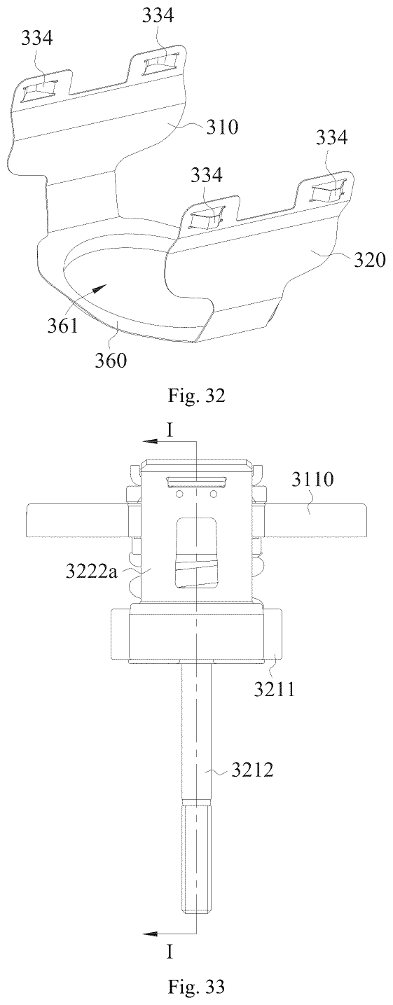

As shown in FIG. 30 to FIG. 32, the movable assembly 3000 of the seventh embodiment of the present disclosure is similar to the movable assembly 3000 of the fifth embodiment and is not described in detail. The difference is that:

The first side wall 3222a and the second side wall 3222b are both provided with a protruding claw 600. Each connection portion 330 includes a sleeve ring 334, and the sleeve rings 334 of two connection portions 330 are respectively sleeved on the outer periphery of the protruding claw 600 of the first side wall 3222a and the outer periphery of the protruding claw 600 of the second side wall 3222b.

In the embodiment of the present disclosure, two protruding claws 600 are provided at one end of the first side wall 3222a away from the base 3211 and are spaced apart from each other along the third direction D3. The first anti-rotation piece 310 is provided with two sleeve rings 334. The two sleeve rings 334 of the first anti-rotation piece 310 are respectively sleeved on the outer peripheries of the two protruding claws 600 of the first side wall 3222a.

The second side wall 3222b is provided with two protruding claws 600 at one end away from the base 3211 and are spaced apart from each other along the third direction D3. The second anti-rotation piece 320 is provided with two sleeve rings 334. The two sleeve rings 334 of the second anti-rotation piece 320 are respectively sleeved on the outer peripheries of the two protruding claws 600 of the second side wall 3222b.

In addition, in the embodiment of the present disclosure, the movable contact assembly 3100 includes one movable contact piece 3110 and two second magnetizers 6200, the movable contact piece 3110 is provided with a via hole, each second magnetizer 6200 is a U-shaped structure, and two adjacent sides of the two U-shaped structures are inserted into one via hole.

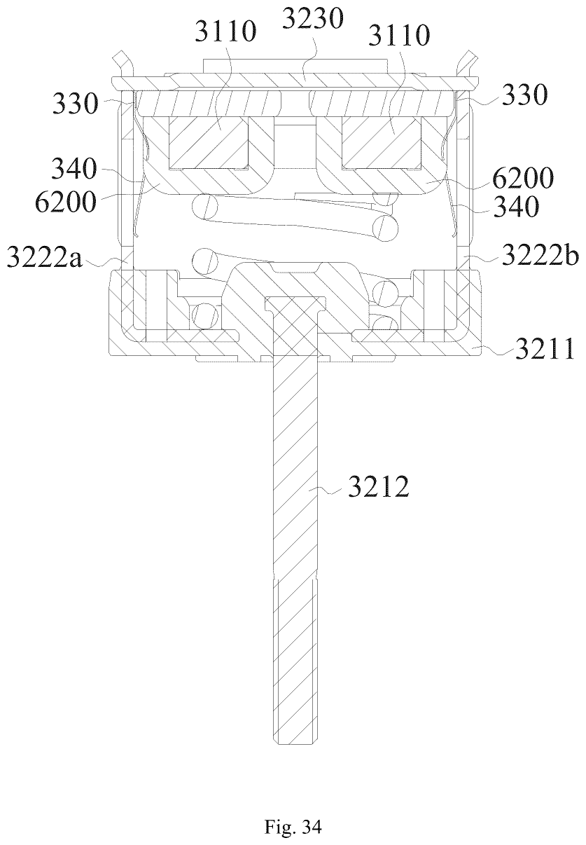

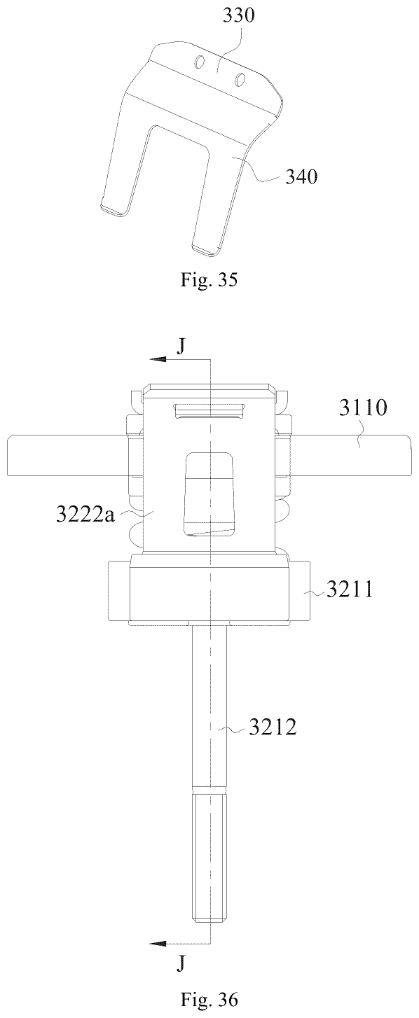

As shown in FIG. 33 to FIG. 35, the movable assembly 3000 of the eighth embodiment of the present disclosure is similar to the movable assembly 3000 of the third embodiment and is not described in detail. The difference is that:

The connection portion 330 of the first anti-rotation piece 310 is riveted to the first inner side surface 3223 of the first side wall 3222a facing the movable contact assembly 3100, and the connection portion 330 of the second anti-rotation piece 320 is riveted to the second inner side surface 3225 of the second side wall 3222b facing the movable contact assembly 3100.

In another embodiment, the connection portion 330 of the first anti-rotation piece 310 is welded to the first inner side surface 3223 of the first side wall 3222a facing the movable contact assembly 3100, and the connection portion 330 of the second anti-rotation piece 320 is welded to the second inner side surface 3225 of the second side wall 3222b facing the movable contact assembly 3100.

In addition, in the embodiment of the present disclosure, the anti-rotation structure 300 further includes a connection piece 360, and one end of the first anti-rotation piece 310 and one end of the second anti-rotation piece 320 are respectively integrally connected to two ends of the connection piece 360 along the third direction D3.

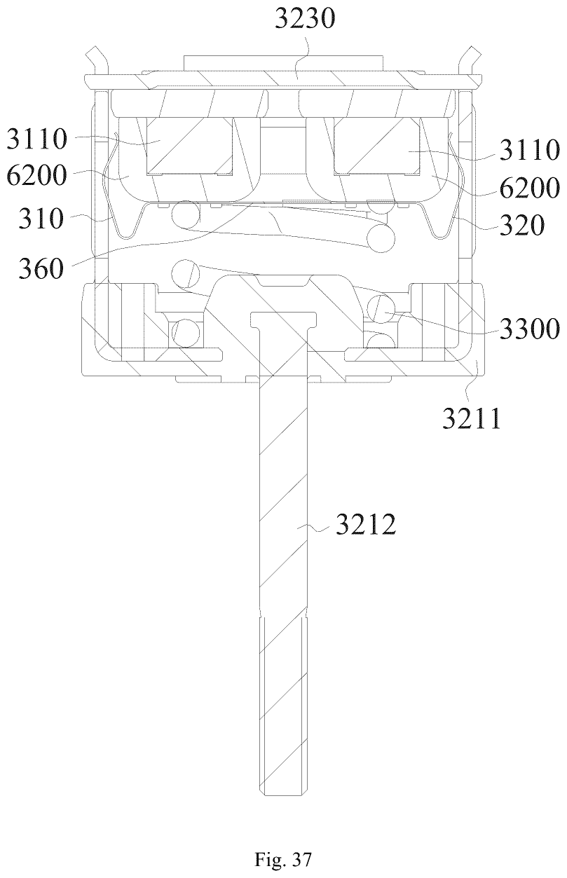

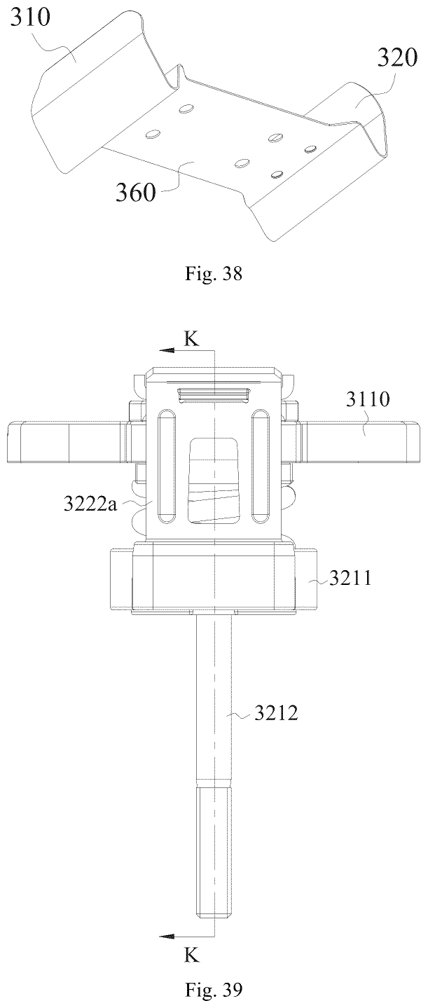

As shown in FIG. 36 to FIG. 38, the movable assembly 3000 of the ninth embodiment of the present disclosure is similar to the movable assembly 3000 of the first embodiment and is not described in detail. The difference is that:

The anti-rotation structure 300 further includes a connection piece 360, one end of the first anti-rotation piece 310 and one end of the second anti-rotation piece 320 are integrally connected to two ends of the connection piece 360 along the third direction D3 respectively; the connection piece 360 is fixedly connected to the movable contact assembly 3100. One end of the elastic assembly 3300 abuts against the base 3211, and the other end abuts against the connection piece 360.

As an example, the connection piece 360 is fixedly connected to the second magnetizer 6200. Further, the connection piece 360 is connected to the second magnetizer 6200 by riveting, welding, etc., but not limited thereto.

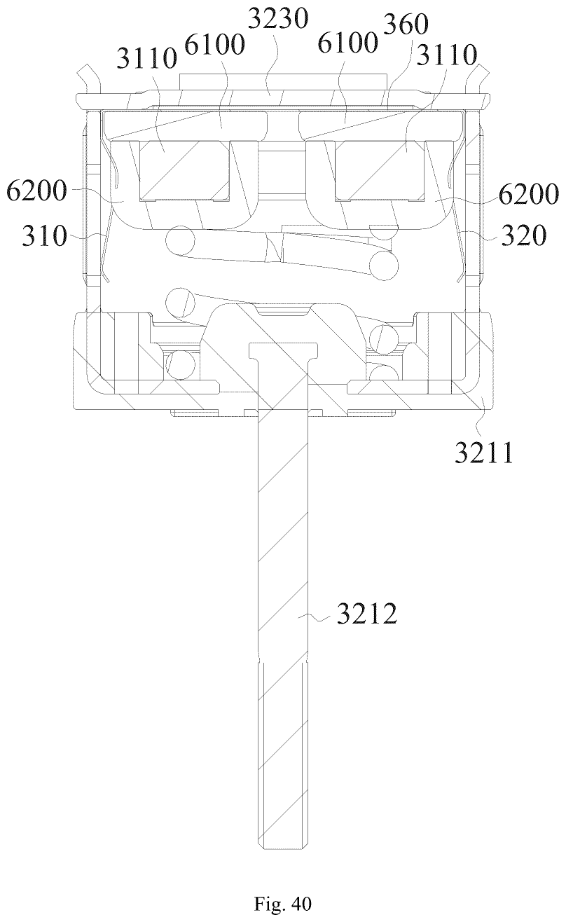

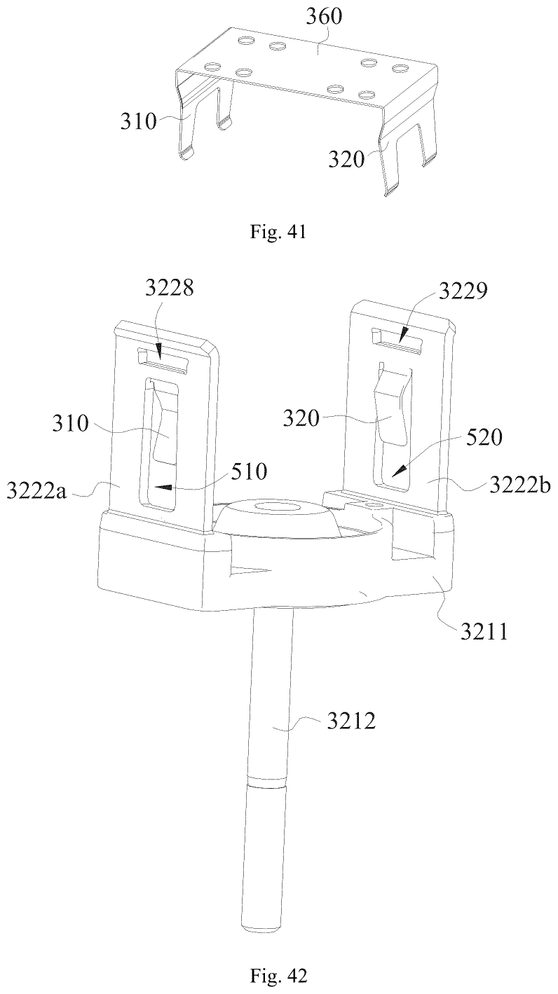

As shown in FIG. 39 to FIG. 41, the movable assembly 3000 of the tenth embodiment of the present disclosure is similar to the movable assembly 3000 of the ninth embodiment and is not described in detail. The difference is that:

The connection piece 360 is disposed between the stop wall 3230 and the first magnetizer 6100, and is fixedly connected to the stop wall 3230 and the first magnetizer 6100. That is, when assembling the push rod assembly 3200, the stop wall 3230, the first magnetizer 6100 and the anti-rotation structure 300 may be firstly fixedly connected to form an integral part, and then the integral part may be connected to the contact bracket 3220.

Furthermore, the stop wall 3230, the first magnetizer 6100 and the connection piece 360 of the anti-rotation structure 300 may be fixedly connected by riveting, welding, etc., but not limited thereto.

As shown in FIG. 42, the movable assembly 3000 of the eleventh embodiment of the present disclosure is similar to the movable assembly 3000 of the first embodiment and is not described in detail. The difference is that:

The first anti-rotation piece 310 and the second anti-rotation piece 320 are both elastic pieces. The first anti-rotation piece 310 is integrally connected to the first side wall 3222a, and the second anti-rotation piece 320 is integrally connected to the second side wall 3222b. The first anti-rotation piece 310 is used to provide a first elastic force to the movable contact assembly 3100, and the second anti-rotation piece 320 is used to provide a second elastic force to the movable contact assembly 3100.

Furthermore, the first side wall 3222a further has a third opening 510, and the second side wall 3222b further has a fourth opening 520. The first anti-rotation piece 310 is integrally connected to the upper edge of the third opening 510, and the second anti-rotation piece 320 is integrally connected to the upper edge of the fourth opening 520.

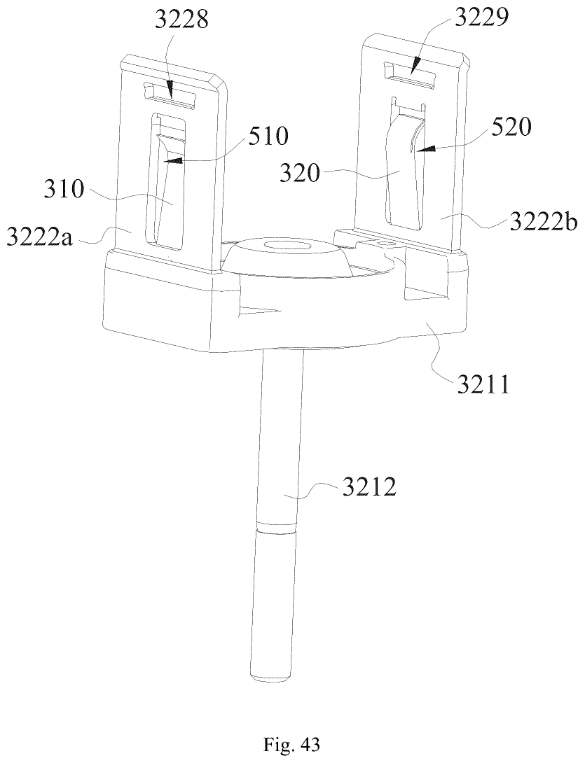

As shown in FIG. 43, the movable assembly 3000 of the twelfth embodiment of the present disclosure is similar to the movable assembly 3000 of the eleventh embodiment and is not described in detail. The difference between the movable assembly 3000 and the eleventh embodiment is as follows:

The first anti-rotation piece 310 is integrally connected to a lower edge of the third opening 510, and the second anti-rotation piece 320 is integrally connected to a lower edge of the fourth opening 520.

It can be understood that in the above-mentioned third to twelfth embodiments, both the first anti-rotation piece 310 and the second anti-rotation piece 320 may be provided with the slots 350.

It can be understood that the various examples/embodiments provided by the present disclosure can be combined with each other without contradiction, and detailed examples are not provided herein.

In the embodiments of the present disclosure, the terms “first”, “second”, “third” are used for descriptive purposes only and should not be understood as indicating or implying relative importance; the term “a plurality of” refers to two or more, unless there is a clear definition otherwise. The terms such as “installation”, “connected”, “connection”, “fixed” should be understood in a broad sense. For example, “connection” can be a fixed connection, or a removable connection, or an integral connection; “connected embodiment” can be directly connected, or indirectly connected through an intermediary medium. For the ordinary skilled person in the art, the specific meanings of these terms in the invention can be understood based on the specific circumstances.

In the description of the embodiments of the present disclosure, the terms “upper”, “lower”, “left”, “right”, “front”, and “rear” indicate a direction or position based on the orientation or position shown in the accompanying drawings. These terms are used only to facilitate the description of the embodiment and to simplify the description, and are not intended to indicate or imply that the device or unit referred to must have a specific direction, be constructed and operated in a specific orientation. Therefore, these terms should not be construed as limiting the embodiments of the invention.

In the description of this specification, terms such as “an embodiment,” “some embodiments,” “a specific embodiment” refer to the specific features, structures, materials, or characteristics described in conjunction with the embodiment or example being included in at least one embodiment or example of the invention. In this specification, the illustrative terms do not necessarily refer to the same embodiment or example. Moreover, the specific features, structures, materials, or characteristics described may be suitably combined in any one or more of the embodiments or examples.

The above description is merely a preferred embodiment of the present disclosure and is not intended to limit the embodiment. For the person skilled in the art, the present disclosure may be subject to various changes and modifications. Any modifications, equivalent substitutions, improvements, and the like made within the spirit and principles of the embodiments of the present disclosure should be included within the scope of protection of the embodiments of the present disclosure.

What is claimed is:

1. A relay, comprising:
a pair of static contact leading-out terminals;
a movable contact assembly, comprising a movable contact piece, two ends of the movable contact piece along a first direction are configured to contact with or separate from the pair of static contact leading-out terminals respectively; the first direction is an arrangement direction of the pair of static contact leading-out terminals, the movable contact assembly has a first side surface and a second side surface arranged along a third direction; wherein a moving direction of the movable contact piece is defined as a second direction, and the first direction, the second direction and the third direction are perpendicular with each other;
a push rod assembly, comprising a contact bracket; the contact bracket has a first side wall and a second side wall along the third direction, the first side wall corresponds to the first side surface, the second side wall corresponds to the second side surface; and
an anti-rotation structure, comprising a first anti-rotation piece and a second anti-rotation piece, the first anti-rotation piece is located between the first side wall and the first side surface, the second anti-rotation piece is located between the second side wall and the second side surface.

2. The relay according to claim 1, wherein the first anti-rotation piece and the second anti-rotation piece are both sheet structures made of flexible materials;
the first side wall has a first inner side surface facing the movable contact assembly, the first anti-rotation piece is attached to the first inner side surface or the first side surface; the second side wall has a second inner side surface facing the movable contact assembly, and the second anti-rotation piece is attached to the second inner side surface or the second side surface.

3. The relay according to claim 1, wherein the first anti-rotation piece and the second anti-rotation piece are both elastic pieces;
the first anti-rotation piece is compressed between the first side wall and the first side surface of the movable contact assembly, configured to provide a first elastic force to the movable contact assembly; the second anti-rotation piece is compressed between the second side wall and the second side surface of the movable contact assembly, configured to provide a second elastic force to the movable contact assembly;
a direction of the first elastic force is opposite to a direction of the second elastic force.

4. The relay according to claim 3, wherein the first anti-rotation piece and the second anti-rotation piece each comprises a connection portion and an elastic sheet portion;
two connection portions of the first anti-rotation piece and the second anti-rotation piece are respectively connected to the first side wall and the second side wall, two elastic sheet portions of the first anti-rotation piece and the second anti-rotation piece extend from the two connection portions respectively in a direction away from the static contact leading-out terminal; the two elastic sheet portions are configured to provide the first elastic force and the second elastic force to the movable contact assembly respectively.

5. The relay according to claim 4, wherein the connection portion of the first anti-rotation piece is riveted to the first inner side surface of the first side wall facing the movable contact assembly, the connection portion of the second anti-rotation piece is riveted to the second inner side surface of the second side wall facing the movable contact assembly.

6. The relay according to claim 4, wherein the first side wall is provided with a first opening and the second side wall is provided with a second opening;
each connection portion comprises a hanging hook, two hanging hooks of the two connection portions are respectively hung on a lower edge of the first opening and a lower edge of the second opening.

7. The relay according to claim 4, wherein the first side wall is provided with a first opening and the second side wall is provided with a second opening;
each connection portion comprises a clamping structure, and the clamping structures of the two connection portions are respectively clamped in the first opening and the second opening.

8. The relay according to claim 7, wherein the first side wall is further provided with a first connecting hole, the second side wall is further provided with a second connecting hole;
each connection portion further comprises a protrusion, and the protrusions of the two connection portions extend in the first connecting hole and the second connecting hole, and are interference-fitted with the first connecting hole and the second connecting hole, respectively.

9. The relay according to claim 4, wherein the first side wall and the second side wall are both provided with a protruding claw;
each connection portion comprises a sleeve ring, the sleeve rings of the two connection portions are respectively sleeved on a periphery of the protruding claw of the first side wall and a periphery of the protruding claw of the second side wall.

10. The relay according to claim 3, wherein the anti-rotation structure further comprises a connection piece;
one end of the first anti-rotation piece and one end of the second anti-rotation piece are respectively integrally connected to two ends of the connection piece along the third direction.

11. The relay according to claim 10, wherein the connection piece has a center hole;
the relay further comprises an elastic assembly, the elastic assembly is connected to the movable contact assembly and the push rod assembly; the elastic assembly is configured to provide a contact pressure to a movable contact assembly;
the elastic assembly passes through the center hole.

12. The relay according to claim 3, wherein the anti-rotation structure further comprises a connection piece;
one end of the first anti-rotation piece and one end of the second anti-rotation piece are respectively integrally connected to two ends of the connection piece along the third direction;
the connection piece is fixedly connected to the movable contact assembly.

13. The relay according to claim 12, wherein the movable contact assembly further comprises a second magnetizer, the second magnetizer is fixedly connected to one side of the movable contact piece facing away from the static contact leading-out terminal;
the connection piece is fixedly connected to the second magnetizer.

14. The relay according to claim 3, wherein the anti-rotation structure further comprises a connection piece;
one end of the first anti-rotation piece and one end of the second anti-rotation piece are respectively integrally connected to two ends of the connection piece along the third direction;
the push rod assembly further comprises a stop wall, two ends of the stop wall along the third direction are connected to the first side wall and the second side wall;
the connection piece is fixedly connected to the stop wall.

15. The relay according to claim 14, wherein the relay further comprises a first magnetizer, the first magnetizer is disposed at one side of the movable contact assembly facing the static contact leading-out terminal;
the connection piece is disposed between the stop wall and the first magnetizer, and is fixedly connected to the stop wall and the first magnetizer.

16. The relay according to claim 1, wherein the first anti-rotation piece is integrally connected to the first side wall, the second anti-rotation piece is integrally connected to the second side wall.

17. The relay according to claim 1, wherein the push rod assembly further comprises a rod portion and a base connected to one end of the rod portion along an axial direction;
the contact bracket further comprises a bottom wall, and the two ends of the bottom wall along the third direction are integrally connected to one ends of the first side wall and the second side wall, the contact bracket, the rod portion and the base are connected by injection molding, and the base wraps the bottom wall and one ends of the first side wall and the second side wall;
the push rod assembly further comprises a stop wall, the stop wall is connected to another ends of the first side wall and the second side wall, and the stop wall is arranged at one side of the movable contact assembly facing the static contact leading-out terminal.

18. The relay according to claim 1, wherein the push rod assembly further comprises a rod portion and a base connected to one end of the rod portion axial along an axial direction;
the contact bracket further comprises a top wall, and the two ends of the top wall along the third direction are integrally connected to one ends of the first side wall and the second side wall;
another ends of the first side wall and the second side wall are respectively clamped on the base.

19. The relay according to claim 1, wherein the relay further comprises a first magnetizer, the first magnetizer is arranged at one side of the movable contact assembly facing the static contact leading-out terminal;
the movable contact assembly comprises a plurality of movable contact pieces and a plurality of second magnetizers, the plurality of movable contact pieces are arranged side by side along the third direction, the plurality of second magnetizers are fixedly connected to one sides of the plurality of movable contact pieces facing away from the static contact leading-out terminal in a one-to-one correspondence; each second magnetizer is configured to form a magnetic circuit with the first magnetizer;
two outermost second magnetizers among the plurality of second magnetizers respectively have the first side surface and the second side surface.

20. The relay according to claim 1, wherein during a whole movement of the push rod assembly, the first anti-rotation piece always abuts between the first side wall and the first side surface, the second anti-rotation piece always abuts between the second side wall and the second side surface.

21. The relay according to claim 1, wherein the first anti-rotation piece and/or the second anti-rotation piece is provided with a slot.
